(19) United States
(12) Patent Application Publication
(10) Pub. No.: US 2026/0238551 A1
(43) Pub. Date: Aug. 13, 2026

(54) AGENTIC ESCALATION FOR IT OPERATIONS

(71) Applicant: ServiceNow, Inc., Santa Clara, CA (US)

(72) Inventors: John Yohahn Lee, San Diego, CA (US); Darius Koohmarey, San Diego, CA (US)

(21) Appl. No.: 19/053,107

(22) Filed: Feb. 13, 2025

(51) Int. Cl. H04L 41/5019; H04L 41/16

(52) U.S. Cl. CPC H04L 41/16

(57) ABSTRACT

Aspects of the subject technology relate to systems, methods, and computer-readable media for providing an agentic escalation framework that allows seamless and automated handoff between an AI agent and a human agent based on various metrics (e.g., time, actions, and/or number of AI agents). An example method can include identifying an incident in a managed network and initiating an incident resolution process, using an AI model, to determine a resolution for the incident. The method can further include tracking one or more performance metrics associated with the incident resolution process and in response to determining that at least one of the one or more performance metrics exceeds a respective threshold, enabling a human agent to participate in the incident resolution process.

### BACKGROUND

### 1. Technical Field

The present disclosure generally relates to virtual assistance systems and more specifically, to providing an agentic escalation framework that allows seamless and automated handoff between an AI agent and a human agent based on various metrics.

### 2. Introduction

Many enterprises utilize a virtual assistant powered by artificial intelligence (AI) designed to perform automated tasks, simulate conversations, or make decisions based on data and predefined rules. For example, AI agents (also called AI bots) for IT operations can be used in incident resolution to streamline and enhance the process of identifying, managing, and resolving issues across various domains, such as IT support, customer service, and operations.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure.

FIG. 1B is a block diagram illustrating an example network architecture that can be used to implement one or more aspects, components, devices, nodes, systems, instances, and/or portions of the example cloud computing architecture, according to some examples of the present disclosure.

FIG. 2 is a diagram illustrating an example virtual assistance system, according to some examples of the present disclosure.

FIG. 3 is a diagram illustrating an example workflow of a virtual assistance system with an automated agentic escalation engine, according to some examples of the present disclosure.

FIG. 4 is a diagram illustrating an example system process for enabling an automated handoff between a human agent and an AI agent per stage, according to some examples of the present disclosure.

FIGS. 5A, 5B, and 5C illustrate example diagrams of an interface of an agentic escalation system, according to some examples of the present disclosure.

FIG. 6 illustrates a flowchart of an example method of facilitating automated handoff between an AI agent and a human agent based on various metrics, according to some examples of the present disclosure.

FIG. 7 is an example of a deep learning neural network that can be used to implement all or a portion of the systems and techniques described herein, according to some examples of the present disclosure.

FIG. 8 illustrates an example processor-based system with which some aspects of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As previously described, many enterprises utilize a virtual assistant powered by artificial intelligence (AI) designed to perform automated tasks, simulate conversations, or make decisions based on data and predefined rules. For example, AI agents (also called AI bots) can be used for IT operations in incident resolution to streamline and enhance the process of identifying, managing, and resolving issues across various domains, such as IT support, customer service, and operations. AI agents can improve efficiency and cost-effectiveness by automating routine tasks and reducing the need for large human teams.

However, AI agents often lack the ability to escalate issues or recognize their limitations since they cannot think outside their programmed boundaries or adapt creatively to new or unforeseen challenges. For example, a bot might loop through incorrect solutions, provide repeated irrelevant responses, or hallucinate in an attempt to generate a resolution, leading to wasted resources and time. When an AI agent fails to resolve an issue, the task can be passed (e.g., escalated) to human operators. However, a human-invoked handoff requires the human operator to manually initiate the escalation, resulting in premature or delayed handoffs. Also, if the handoff is poorly managed or incomplete, the human support team may lack the necessary context, further slowing resolution.

The disclosed technology addresses the foregoing by providing an agentic escalation framework that allows seamless and automated handoff between an AI agent and a human agent based on various metrics such as time, actions, and/or number of AI agents. For example, the disclosed technology can dynamically determine when to escalate from an AI agent to a human agent for each stage of an incident resolution process (e.g., issue detection, impact assessment, issue identification, root-cause analysis, remediation actions, documentation, etc.). As follows, a timely escalation at an individual workflow stage can be achieved, thereby improving the resource use and efficiency of the incident resolution process.

Furthermore, the disclosed technology can provide solutions for improving the efficiency of an agentic escalation by providing a human agent with a comprehensive overview of the handoff for the given stage such as attempted solutions or activities, reasons and/or evidence, history, and so on. Such context sharing can facilitate an efficient and seamless transition between an AI agent and a human agent by ensuring that the human agent does not repeat the unsuccessful solutions and helping with contextual understanding.

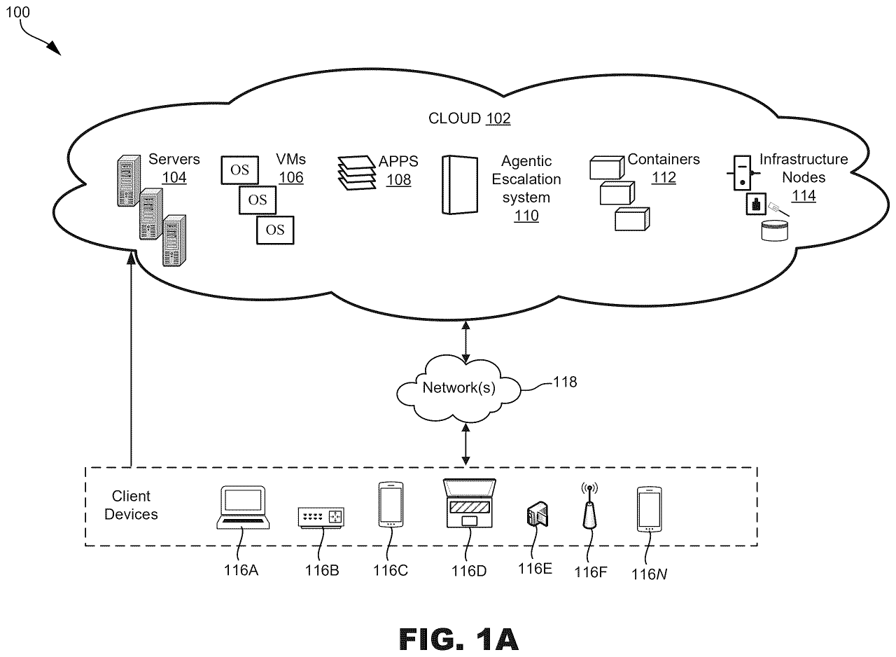

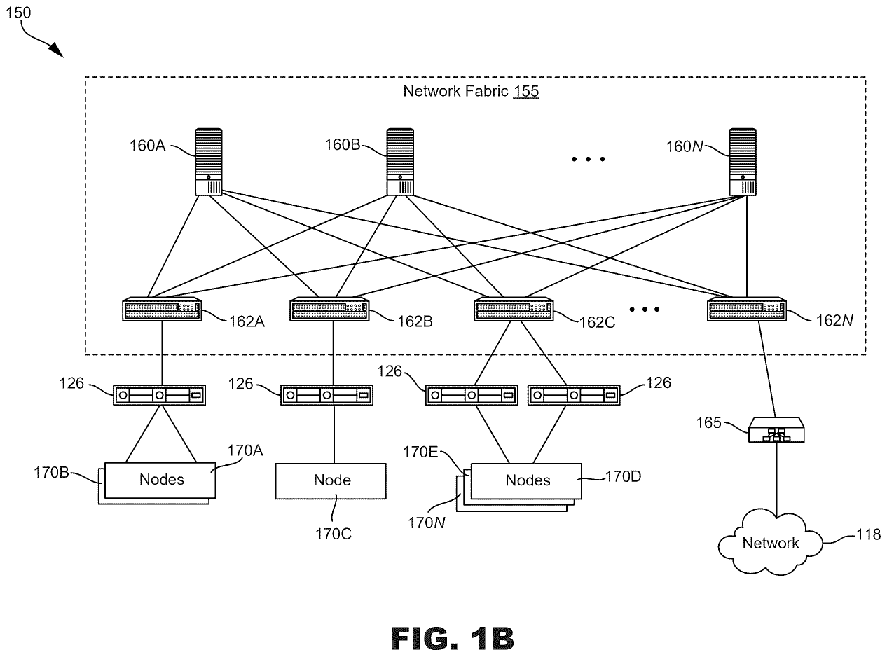

FIG. 1A illustrates a diagram of an example cloud computing environment 100 that can be used to implement an agentic escalation system, according to some examples of the present disclosure. The cloud computing environment 100 can include and/or represent a cloud 102. The cloud 102 can include one or more private clouds, public clouds, and/or hybrid clouds. Moreover, the cloud 102 can include cloud elements 104-114. The cloud elements 104-114 can include or represent, for example, servers 104, virtual machines (VMs) 106, applications or services 108, agentic escalation system 110, software containers 112, and/or infrastructure nodes 114. The infrastructure nodes 114 can include various types of nodes, such as compute nodes, storage nodes, network nodes, management systems, etc.

The cloud 102 can provide cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client devices 116A-N (collectively referred to as “client devices 116” hereinafter) can connect with the cloud 102 to obtain one or more specific services from the cloud 102. The client devices 116 can connect with the cloud 102 from any network of the client devices 116 such as a local area network (wired and/or wireless), a cellular network, and/or any other network, and using the network(s) 118 to transport communications between the cloud 102 and the client devices 116. For example, the client devices 116 can communicate with the cloud 102 and/or any of the elements 104-114 via a network(s) 118. The network(s) 118 can include one or more public networks (e.g., the Internet, a wide area network, etc.), one or more private networks (e.g., local area network(s), wireless local area network(s), private backbone network(s), etc.), and/or one or more hybrid networks (e.g., virtual private network(s), public and private cloud network(s), etc.).

The client devices 116 can include any device with networking capabilities, such as a laptop computer, a tablet computer, a server, a desktop computer, a smartphone, a network device (e.g., an access point, a router, a switch, etc.), a smart television, a smart car, a sensor system, a gaming console, a smart wearable device (e.g., smartwatch, etc.), an internet of things (IoT) device, a camera, a network printer, or any other computing device.

In some examples, the cloud 102 can implement agentic escalation system 110 associated with one or more entities. The client devices 116 can access the agentic escalation system 110 implemented and/or hosted in the cloud 102 to look for a resolution for an incident occurred in a network, as further described herein. An example network architecture that can be used to implement a network or datacenter (or any portion thereof), such as the cloud 102, is shown in FIG. 1B and further described below. In some cases, one or more services, components, devices, nodes, systems, instances, and/or portions of the example network architecture 150 shown in FIG. 1B can be implemented by and/or in a cloud network or datacenter, such as the cloud 102.

FIG. 1B is a block diagram illustrating an example network architecture 150 that can be used to implement one or more portions of the example cloud computing environment 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run workloads/nodes. In some cases, a cloud node can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the node can host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, the cloud 102. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126, the network device 165, and/or the nodes 170A-N (collectively referred to as “nodes 170” hereinafter) with any portion of the network fabric 155 (e.g., including each other). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g., network 118, various network elements, the network device 165, the nodes 170, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. For example, the system servers 126 can implement any of the applications 108 and/or the agentic escalation system 110 hosted on the cloud 102. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170. In some examples, the nodes 170 can represent cloud instances. For example, in some cases, the nodes 170 can each represent a virtual server and/or environment (e.g., a VM, a software container, etc.) that uses compute, memory, storage, and/or networking resources on the cloud (e.g., network architecture 150) for respective workloads. For example, the nodes 170 can implement any of the applications 108 and/or the agentic escalation system 110 hosted on the cloud 102. In some implementations, the nodes 170 can perform parallel computing using, for example, multithreading. Each of the nodes 170 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 can represent a node instance that includes, implements, hosts, and/or runs a software container(s), an application(s), and/or an agentic escalation system(s). In some examples, a software container(s) associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, and/or the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

An enterprise network and/or a agentic escalation system associated with an entity can be implemented through the cloud computing environment 100 shown in FIG. 1A and the network architecture 150 shown in FIG. 1B. For example, user interfaces, data structures, and logic to implement the agentic escalation system 110 and perform the automated handoff between an AI agent and a human agent can be implemented through the cloud computing environment 100 and/or the network architecture 150.

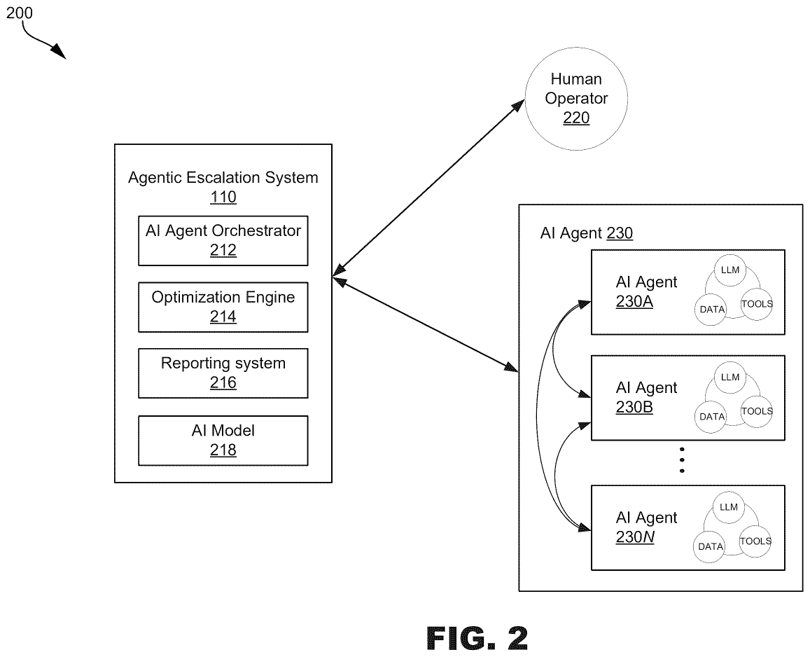

FIG. 2 illustrates an example virtual assistance system 200 for facilitating an automated handoff between an AI agent and a human agent, according to some examples of the present disclosure. The virtual assistance system 200 can be implemented in an incident resolution process where agentic escalation system 110 is configured to determine when to escalate from an AI agent 230 to a human operator 220 during the incident resolution process. Specifically, agentic escalation system 110 can monitor the performance of AI agent 230 during the incident resolution process and determine when to transfer (e.g., handoff) the task to human operator 220 based on various performance metrics.

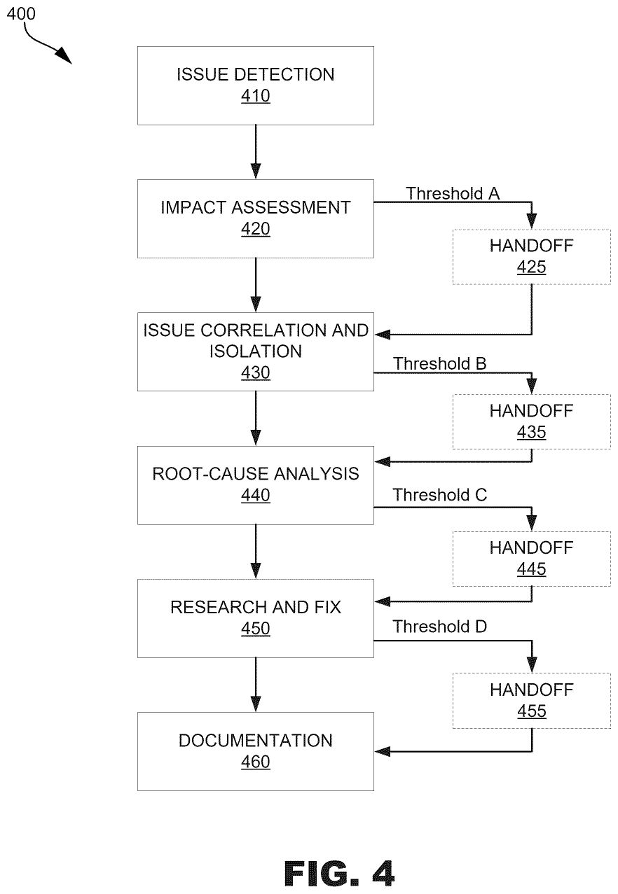

An incident resolution process may involve identifying, analyzing, and fixing issues in IT operations. A lifecycle of the incident resolution process can comprise a plurality of stages such as issue detection, impact assessment, issue correlation and isolation, issue diagnosis (e.g., root-cause analysis), research and fix, documentation, and so on. As previously mentioned, agentic escalation system 110 can be implemented through cloud computing environment 100 and/or network architecture 150 to carry out the incident resolution process. Further details about each stage of the incident resolution process relating to agentic escalation system 110 are described below with respect to FIG. 4.

In some examples, agentic escalation system 110 includes an AI agent orchestrator 212, which is configured to monitor the performance of AI agent 230 by keeping track of various performance metrics such as a duration, a count (e.g., a number of actions), and/or a number of AI agents during the incident resolution process. Specifically, for each stage of the incident resolution process, AI agent orchestrator 212 may compare the performance metrics of AI agent 230 with a corresponding threshold to determine whether the task assigned to AI agent 230 needs to be handed off to human operator 220.

For example, AI agent orchestrator 212 can determine an amount of time (e.g., an elapsed time) that AI agent 230 has been attempting to complete the task given at the respective stage of the incident resolution process. If the elapsed time exceeds a duration threshold, AI agent orchestrator 212 may transfer the task to human operator 220 to take over. In some examples, a duration threshold can be customized based on types or conditions of the incident. For example, AI agent orchestrator 212 may allow AI agent 230 to diagnose the issue for 20 minutes for an incident with a high priority while 5 minutes can be given for an incident with a low priority such that AI agent 230 is given a longer time to try various actions or approaches to complete the task for a prioritized incident.

Further, AI agent orchestrator 212 can keep track of a number of actions that AI agent 230 has been taking to complete the task given at the respective stage of the incident resolution process. For example, AI agent orchestrator 212 can count a number of API calls that AI agent 230 makes, a number of queries or calls made to a machine learning (ML) model such as a large language model (LLM), etc. at each stage of the incident resolution process. If the number of actions or attempts exceeds a count threshold, AI agent orchestrator 212 may transfer the task to human operator 220.

Also, AI agent orchestrator 212 can determine a number of AI agent(s) 230 that have been involved in attempting to complete the task given at the respective stage of the incident resolution process. In some examples, AI agent 230 can include one or more AI agents 230A-N (collectively, AI agent(s) 230) that can be used for the incident resolution process. Each of AI agents 230A-N can be responsible for different tasks (e.g., anomaly detection, text generation, research and plan, log analysis, etc.). For example, AI agent 230A can include a Research & Plan AI agent, which is configured to gather similar knowledge articles, incidents, cases, tasks, etc. as the current task being worked on and transform this data into a business context aware plan. Also, AI agent 230B can include a log analysis AI agent, which is configured to create a plan to solve any anomalies detected based on the unstructured text data and quantitative metrics emitted by monitoring systems. AI agent 230C (not shown) can include an IT Operations Management (ITOM)/IT service management (ITSM) response AI agent, which is configured to incorporate plan from other AI agents to trigger actions to bring task to completion (e.g., assignment of priority, coordination of human agents, engineers, and operators, etc.). The AI agents 230A-N can collaborate with each other at a given stage on the assigned task. For example, AI agent 230 may communicate with AI agent 230B or bring another AI agent 230C in to perform its task. As follows, AI agent orchestrator 212 can count the total number of AI agents 230 that have engaged in attempting to complete the task. If the number of AI agent(s) 230 exceeds an agent threshold, AI agent orchestrator 212 may transfer the task to human operator 220.

In some examples, when at least one of the performance metrics (e.g., a duration, a count, a number of agents, etc.) exceeds a corresponding threshold, AI agent orchestrator 212 may automatically initiate a handoff between AI agent 230 and human operator 220. For example, at an impact assessment stage where a duration threshold is 20 minutes, a count threshold is 40 actions, and an agent threshold is 5 agents, if AI agent 230 has timed out or exhausted 20 minutes while attempting 20 actions, AI agent orchestrator 212 may transfer the impact assessment task to human operator 220 for task completion.

In some implementations, AI agent orchestrator 212 can identify, recommend, or appoint human operator 220 within an entity based on organizational data and/or data stored in a configuration management database (CMDB) such as mapping of a network that the incident occurred. For example, AI agent orchestrator 212 may access and analyze the CMDB data, which includes information about who owns or manages specific assets or services that may be associated with the incident at issue. As follows, AI agent orchestrator 212 may identify an organizational unit (e.g., a team, a business unit, etc.) within an entity by analyzing and understanding the context of the incident. Further, AI agent orchestrator 212 can contact or notify the appropriate person within the organization based on the support group of the impacted configuration item (CI) or the on-call user in the assignment group assigned to the record/incident to take over the task from AI agent 230.

In some examples, agentic escalation system 110 includes an optimization engine 214, which is configured to recommend or dynamically adjust a threshold that defines when a handoff needs to occur. The optimization engine 214 may perform a cost analysis and determine an escalation level(s) where a task can be transferred from AI agent 230 to human operator 220 before wasting compute resources and time. For example, every action or attempt that AI agent makes (e.g., adding a comment, routing a server, etc.) creates compute cost. The optimization engine 214 can define a performance threshold (e.g., duration threshold, count threshold, agent threshold, etc.) based on various considerations such as rules provided in a service-level agreement (SLA), historical data, simulation data, current performance of AI agent 230, or a combination thereof. Further, optimization engine 214 may dynamically adjust a threshold in real time. For example, optimization engine 214 may, using AI model 218, learn the performance of AI agent 230 (e.g., a time/duration, a number of actions, a number of AI agents, etc.) and the progress and status of the incident resolution and adjust the threshold accordingly in order to optimize the resource usage and achieve its goal (e.g., incident resolution).

In some examples, if AI agent 230 has been consistently underperforming, optimization engine 214 may make a recommendation on the configuration. For example, if AI agent 230 keeps timing out, optimization engine 214 may recommend a higher duration threshold if AI agent 230 is close to solving the issue. In another example, if AI agent 230 is consistently running out of actions, optimization engine 214 may recommend or adjust to a higher count threshold.

In some cases, optimization engine 214 can recommend or define a threshold based on historical data, which includes past data representing how human agent(s) have performed in the same type of incident such that AI agent 230 can provide better performance than a human agent. For example, optimization engine 214 may utilize historical data that includes incident resolution with similar configuration item, type of incident, etc. to determine a threshold for a current incident resolution process. If an AI agent was close to solving a high volume of issues, a higher threshold can be recommended or defined. If the average performance metric (e.g., time/duration, a number of actions, a number of AI agents, etc.) in the past is much lower, a lower threshold can be recommended or defined. Further, optimization engine 214 may indicate cost vs. benefit of adjusting the threshold to be raised or lowered.

In some implementations, optimization engine 214 can recommend or determine a threshold based on simulation data. For example, optimization engine 214 can use LLM to generate synthetic simulated data that relates to an incident resolution process at issue. Based on how simulated AI agent performed, optimization engine 214 can define a threshold or adjust the threshold to be increased or lowered.

In some examples, agentic escalation system 110 includes reporting system 216, which is configured to provide a document or report describing the performance of AI agent 230 or the progress or status of the incident resolution process. For example, a reporting system 216 can generate a summary of activities that AI agent 230 has attempted until the point of escalation, for the given stage and provide the report to human operator 220 at a handoff. As follows, reporting system 216 can provide human operator 220 with a comprehensive context such that human operator 220 can avoid attempts or actions that have been taken by AI agent 230 and unsuccessful. The reporting system 216 can further provide governance visibility into the performance of AI agent 230.

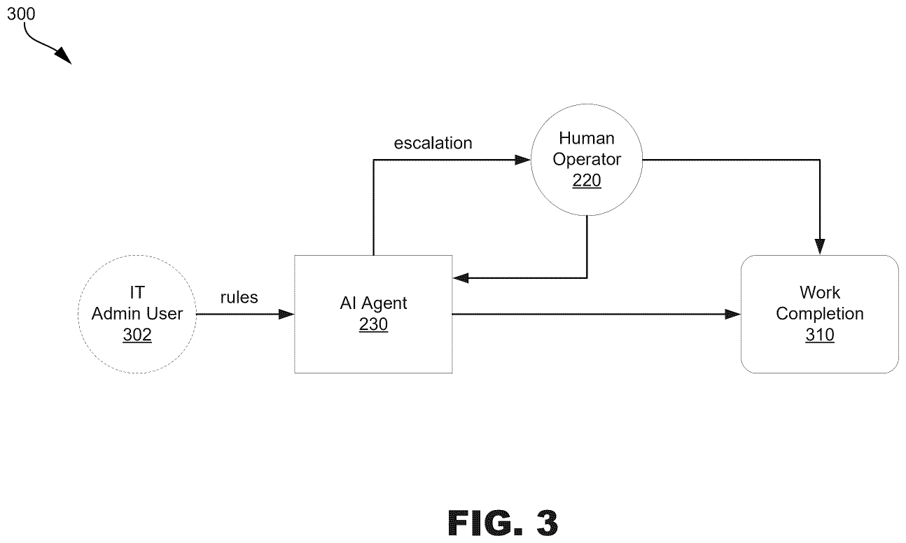

FIG. 3 is a diagram illustrating an example workflow 300 of a virtual assistance system with an automated agentic escalation engine (e.g., agentic escalation system 110), according to some examples of the present disclosure. In this example, IT administration user 302 may provide, to AI agent 230, rules (e.g., service-level agreement (SLA) or organizational agreement) associated with AI agent escalation. Based on the rules, AI agent 230 can perform an incident resolution process to resolve the incident (e.g., to achieve work completion 310), by either escalating a task to human operator 220 or completing the work exclusively by AI agent 230.

In some examples, AI agent 230 may receive, from IT administration user 302, escalation rules that define states and/or conditions for when and how to run the escalation (e.g., handoff between human operator 220 and AI agent 230). For example, an agentic escalation system (e.g., agentic escalation system 110 as illustrated in FIG. 2) can transfer the task, which was assigned to AI agent 230, to human operator 220 as specified in the escalation rules. In some examples, IT administration user 302 may provide rules that define a condition for an escalation or handoff (e.g., a condition that triggers or does not trigger the escalation). For example, rules can define a level of sensitivity or priority of an incident that prompts the escalation.

Further, escalation rules can specify a time duration, a count (e.g., a number of actions), or a number of AI agents that can be taken during the incident resolution process. For example, the rules (e.g., SLA) may define a duration threshold, a count threshold, and an agent threshold for each stage of the incident resolution process that AI agent 230 is allowed to perform. When it is determined that at least one of the time duration, the number of actions taken by AI agent 230, the number of AI agents 230 has exceeded a corresponding threshold, the task can be transferred from AI agent 230 to human operator 220.

In some examples, different rules can be applied for defining a threshold. Specifically, a threshold can vary based on the type of the incident (e.g., a sensitivity of the incident, an impact of the incident, etc.). For example, an incident with high priority can be given a longer time period, a higher count, and/or a higher number of AI agents compared to an incident with low priority. In another example, an incident with high sensitivity can be given a longer time period, a higher count, and/or a higher number of AI agents compared to an incident with low sensitivity. Further, a threshold can be customized per stage. For example, a time duration threshold for a particular incident may have a different value in each of the stages of the incident resolution process.

In some implementations, once human operator 220 finishes the task transferred from AI agent 230 at the given stage, human operator 220 may proceed to the next stage and complete the rest of the incident resolution process (e.g., work completion 310). In other examples, human operator 220 may complete the task at the given stage where the escalation occurred and reassign AI agent 230 to continue the incident resolution process to achieve work completion 310.

In some cases, rules (e.g., SLA) may define parts, tasks, or stages of the incident resolution process that can be performed by human operator 220 and/or AI agent 230. For example, if IT administration user 302 would prefer the research and fix stage to be performed by human operator 220, rules can be provided to AI agent 230 to hand over the work to human operator 220 when it reaches the research and fix stage.

In some examples, escalation rules (e.g., in SLA) can define, on a consumption-based pricing scenario, the number of tokens generated or the number of consumption-based credits used by AI agent 230. Further, escalation rules can include negative sentiment threshold from an end-use(s) that AI agent 230 is interacting with, scenarios or conditions that AI agent 230 cannot complete the task or the request is unusual, confidence threshold (e.g., escalation level to transfer to human operator 220 if an answer provided by AI agent 230 has a low confidence that is below the confidence threshold), and so on.

FIG. 4 is a diagram illustrating an example system process 400 for enabling an automated handoff between a human agent and an AI agent per stage, according to some examples of the present disclosure. Process 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Process 400 shall be described with reference to FIG. 2. However, method 600 is not limited to that example.

The system process 400 illustrates a lifecycle of an incident resolution process, which comprises multiple stages/steps such as issue detection 410, impact assessment 420, issue correlation and isolation 430, root-cause analysis 440 (e.g., issue diagnosis), research and fix 450, and documentation stages 460. For each stage, agentic escalation system 110 monitors the performance of AI agent 230 and determines whether at least one of the performance metrics exceeds a corresponding threshold (e.g., threshold A, threshold B, threshold C, threshold D, etc.). If AI agent 230 is stuck at a certain stage without any progress or fails to complete the task within an available time or allotted number of actions or agents (e.g., the performance metrics exceeding the respective threshold), agentic escalation system 110 can transfer the task to human operator 220. The human operator 220 may hand back off to AI agent 230 once the task is complete, and AI agent 230 may proceed with the incident resolution process. When human operator 220 reassigns AI agent 230 for the next stage/step, a monitor or tracker for a time, a number of actions, a number of AI agents resets for the new stage.

At step 410, agentic escalation system 110 can detect an incident, which may include anomalies from logs, metrics, or traces, diagnosis of IT outages and degradations, for example, based on the performance of a task or with respect to operation of an application or a device. Non-limiting examples of an incident can include network issues, connectivity, high latency, high CPU usage, VPN issues, and so on. When the incident is detected, agentic escalation system 110 may assign AI agent 230 to resolve the identified incident. In some examples, issue detection 410 can be based on a ticket or a message received from a user that notifies an issue in a network. For example, agentic escalation system 110 may receive a ticket describing an incident that has occurred and needs to be resolved. In some examples, agentic escalation system 110 can detect an incident using AI model 218. For example, agentic escalation system 110 may monitor the performance or operation and automatically detect, using AI model 218, an anomaly in a network based on logs and metrics.

Upon issue detection, agentic escalation system 110 may assign AI agent 230 to resolve the issue and proceed to the next step 420, which includes an impact assessment of the incident/issue. For example, at step 420, AI agent 230 is given a task to assess, analyze, and understand the impact based on affected users, service level indicators (SLIs), service level objectives (SLOs), and so on.

If AI agent 230 does not complete the task of impact assessment within an allotted time, a number of actions, or a number of AI agents, agentic escalation system 110 can transfer the task to human operator 220 (step 425). For example, agentic escalation system 110 can monitor the performance of AI agent 230 of impact assessment by monitoring various metrics such as an elapsed time, a number of actions, a number of AI agents. If at least one of the performance metrics exceeds Threshold A, the task can be handed off to human operator 220 (step 425). The threshold A can include a duration threshold, a count threshold, and/or an agent number threshold allotted for the impact assessment stage.

Once human operator 220 completes the impact assessment, agentic escalation system 110 may proceed to step 430, which includes issue correlation and isolation. For example, at step 430, AI agent 230 is given a task to identify patterns or a source of the problem (e.g., reviewing recent changes or updates that may have triggered the problem), isolate the issue to prevent further impact, and/or distinguish between related and unrelated issues. In some examples, agentic escalation system 110 can use AI model 218 (e.g., generative AI) to review system logs, error messages, and/or alerts from monitoring tools, isolate the faulty component, identify the team or business unit.

The agentic escalation system 110 may monitor the performance metrics of AI agent 230 regarding the issue correlation and isolation in view of Threshold B, which may include a time duration threshold, a count threshold, and/or an agent number threshold allotted for the issue correlation and isolation stage. If at least one of the performance metrics exceeds the respective Threshold B, agentic escalation system 110 can trigger the handoff where human operator 220 is to take over the issue correlation and isolation task at step 435. The human operator 220 completes the issue correlation and isolation and may reassign AI agent 230 for the next stage, which includes root-cause analysis.

At step 440, AI agent 230 can be given a task of a root-cause analysis, which includes identifying the underlying reason for the issue and validating the root cause. For example, AI agent 230 may attempt to pinpoint and validate the root cause by testing hypotheses or simulating the conditions that triggered the incident. Furthermore, AI agent 230 responsible for root-cause analysis can search for relevant contextual data (e.g., logs of impacted systems, monitoring data from monitoring tools, similar incidents, similar resolved incidents, unstructured text data notes, etc.) to create a reasoned and context-aware inference about the root cause. From this, AI agent 230 can use a variety of reasoning tools to validate the inference (e.g., hypothesis) such as validating or checking in with human agent(s) and simulating the root cause.

If AI agent 230 fails to complete the root-cause analysis task within the given time, a number of actions, or a number of AI agents that are defined by Threshold C, agentic escalation system 110 may escalate the task to human operator 220 at step 445. Once human operator 220 completes the root-cause analysis task, agentic escalation system 110 may proceed to the next step 450 of research and fix.

At step 450, agentic escalation system 110 can give AI agent 230 a task of research and fix, which includes researching possible solutions, developing and testing the fix or remediation actions, implementing the fix in production, validating the fix, and so on. For example, AI agent 230 may attempt to consult various knowledge bases, past incident records, or documentation, collaborate with subject matter experts, and choose an appropriate solution (e.g., configuration change, patch update, rollback, restart, etc.). Further, AI agent 230 may attempt to implement the remediation action by scheduling downtime, applying the fix using management procedures, or notifying affected users.

If AI agent 230 fails to make progress in the research and fix stage, the task can be transferred to human operator 220 to take over. For example, agentic escalation system 110 may compare the performance metrics of AI agent 230 at the research and fix stage with Threshold D (e.g., a time duration threshold, a count threshold, and/or an agent number threshold) and initiate the handoff (step 455) if at least one of the performance metrics exceeds Threshold D. The human operator 220 may complete the research and fix task and hand off back to AI agent 230.

At step 460, agentic escalation system 110 can assign AI agent 230 with the task of documentation and workaround automation. For example, at step 460, AI agent is given a task to document findings, generate a report with details on the problem/incident, findings, and resolution steps, generate a proposal with corrective actions, and/or automate a workaround, which includes generating a text-to-workflow, testing automation in a lab workspace, and so on.

In some implementations, one or more stages can be owned or initiated by a human agent (e.g., human operator 220) as previously illustrated. For example, a research and fix stage can be initially performed by a human operator without assigning the task to AI agent 230, for example, based on user preferences. Also, human operator 220 may complete the task that is transferred at handoff and further complete the next stage or the rest of the incident resolution process. For example, human operator 220 may take over the task of a root-cause analysis at step 445, and may continue to the research and fix stage at step instead of handing off back to AI agent 230.

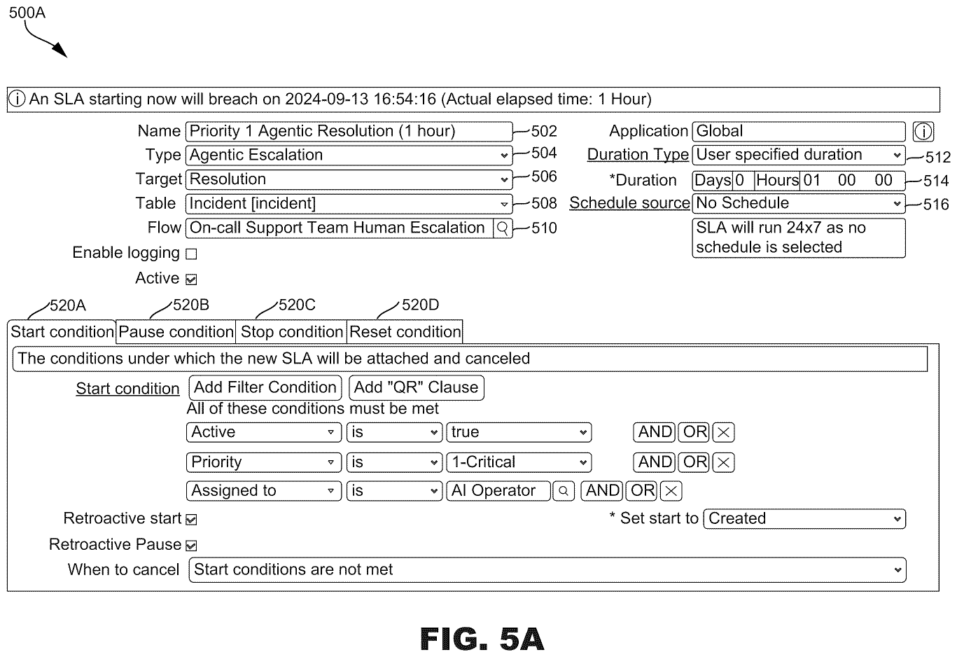

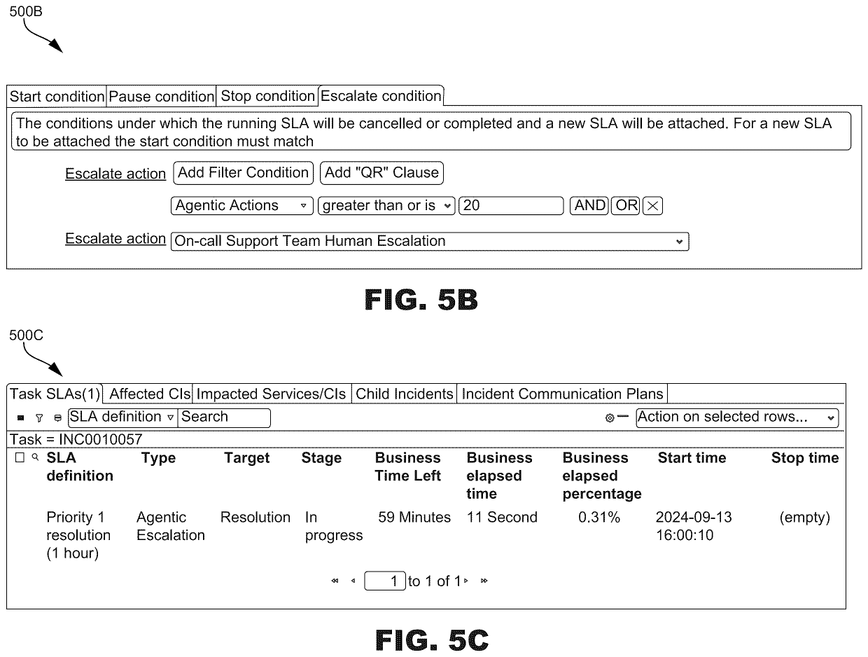

FIGS. 5A, 5B, 5C are example diagrams 500A, 500B, 500C illustrating a user interface (UI) of an agentic escalation system, according to some examples of the present disclosure. In FIG. 5A, UI 500A illustrates a time/duration-based escalation system. As shown in UI 500A, a user can specify name 502 including a level of priority and determine type 504, target 506, table 508, and so on from a drop down list. A user also can determine flow 510, which can be on-call support team human escalation as shown in UI 500A.

Each core state within an alert or incident workflow can have a defined maximum threshold, or a global threshold can be used for resolution. For example, a duration type can be selected as either user specified duration or a global duration. As follows, a user can determine a duration type 512 and set the time for how long the AI agent (e.g., AI agent 230) can attempt the task completion before escalation in duration block 514. As previously described, the time/duration can be determined per stage (e.g., by the granularity of each lifecycle stage change). A user can determine schedule source 516 to choose whether to schedule when to run the agentic escalation system.

For different conditions (e.g., start condition 520A, pause condition 520B, stop condition 520C, reset condition 520D, etc.), a user can specify when to start, pause, stop, or reset the escalation and how to manage the escalation as shown in UI 500A.

In FIG. 5B, UI 500B illustrates an action-based escalation system. As shown in UI 500B, a user can set a number of agent actions that AI agent 230 can attempt before escalating. For example, a user can set an escalation action to be triggered if the number of agentic actions is greater than or is 20 as illustrated in UI 500B. Further, escalation action can be defined, for example as on-call support team human escalation. As this can be defined per ‘stage’ in a process, once a human agent (e.g., human operator 220) moves a record to the next stage, an agentic AI (e.g., AI agent 230) can be reassigned to complete the work.

In FIG. 5C, UI 500C illustrates a real-time escalation remainder. For example, UI 500C includes a view of the remaining time until escalation/handoff from an agentic agent (e.g., AI agent 230) to a human agent (e.g., human operator 220). The UI 500C allows a user to track the progress of the performance of AI agent 230 in real time. For example, UI 500C shows various details of the progress such as SLA definition, type, target, stage, business time left, business elapsed time, business elapsed percentage, start time, stop time, etc.

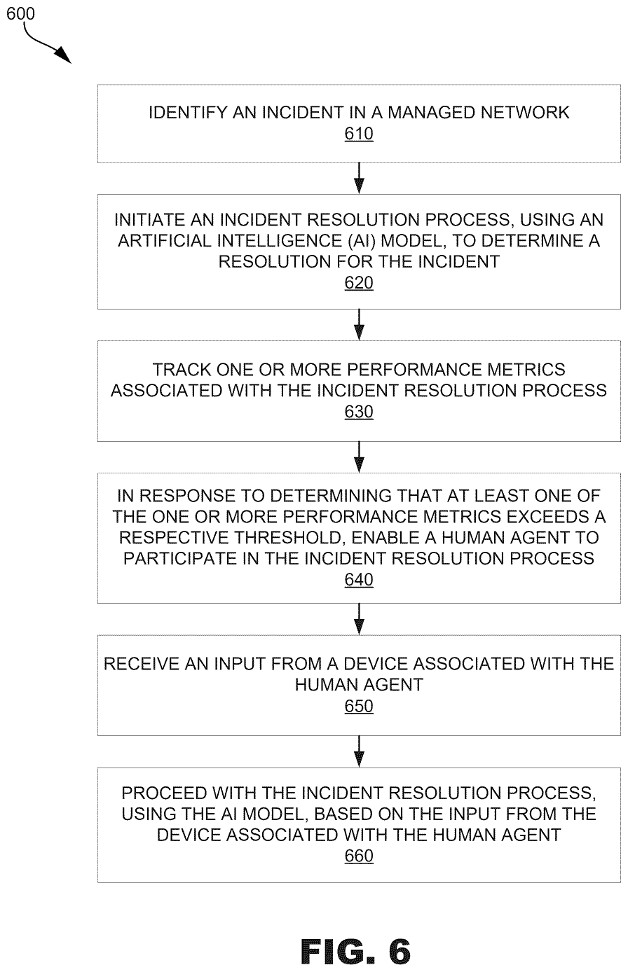

FIG. 6 illustrates a flowchart of an example method 600 for facilitating automated handoff between an AI agent and a human agent based on various metrics, according to some examples of the present disclosure. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art. Method 600 shall be described with reference to FIG. 2. However, method 600 is not limited to that example.

At step 610, method 600 includes identifying an incident in a managed network. For example, agentic escalation system 110 can identify an incident in a managed network such as an anomaly, IT outages, IT degradations, network issues, connectivity, high latency, high CPU usage, VPN issues, and so on. In some implementations, an incident resolution process (e.g., system process 400) can be triggered or initiated when an incident is identified in a network. Upon incident detection, AI agent 230 can be assigned to resolve the incident.

In some examples, agentic escalation system 110 can use AI model 218 to detect an incident in a managed network that needs to be resolved. For example, AI model 218 can be used to monitor logs, traces, metrics, alerts, messages, etc., and detect an incident that would trigger the incident resolution process. The monitoring and incident detection utilized by an AI model can provide technical benefits. Compared to human-initiated issue detection, automatic monitoring and detection by the AI model can reduce downtime, and therefore, an incident can be detected in real time without manual input from a human. As follows, an incident can be promptly attended to for possible remedial actions, thereby improving the efficiency of the incident resolution process.

At step 620, an incident resolution process can be initiated, using an AI model, to determine a resolution for the incident. For example, agentic escalation system 110 can initiate, using AI model 218, an incident resolution process to determine a resolution for the incident. The incident resolution process, as illustrated with respect to FIG. 4, may comprise stages such as issue detection, impact assessment, issue identification, issue diagnosis, root-cause analysis, remediation actions, documentation, etc.

At step 630, method 600 includes tracking one or more performance metrics associated with the incident resolution process. For example, agentic escalation system 110 can track, measure, and/or monitor one or more performance metrics associated with the incident resolution process such as a time duration, a number of actions, a number of AI agent(s), and so on. The real time monitoring and tracking of the AI agent performance can provide technical benefits such as the efficiency, reliability, and quality of the performance of AI agent during the incident resolution process.

At step 640, method 600 includes enabling a human agent to participate in the incident resolution process in response to determining that at least one of the one or more performance metrics exceeds a respective threshold. For example, agentic escalation system 110 can enable human operator 220 to participate in the incident resolution process (e.g., handoff from AI agent 230 to human operator 220) in response to determining that at least one of the one or more performance metrics exceeds a respective threshold. The automated and seamless handoff from an AI agent to a human agent can provide numerous technical benefits such as timely escalation, optimized compute cost, and so on. For example, when an AI agent fails to resolve an issue, the present disclosure allows timely escalation at an individual workflow stage, thereby improving the resource usage and efficiency of the incident resolution process. The automated handoff based on the performance of an AI agent can ensure that an issue/incident gets resolved in a timely manner and for the right cost.

Further, method 600 can include defining or adjusting a threshold for the performance metrics of the AI agent. For example, agentic escalation system 110 (e.g., optimization engine 214) can recommend, define, or adjust a threshold (e.g., a time/duration threshold, a count threshold, an agent number threshold, etc.) based on historical data, current performance, rules provided by a user, SLAs, or a combination thereof. The agentic escalation system can analyze the cost of the performance of AI agent before bringing in a human agent in view of the performance metrics (e.g., time/duration, a number of actions, a number of AI agents) to determine a threshold that optimizes the cost and benefit. The dynamically adjustable threshold for performance metrics can provide various technical benefits such as optimizing the usage of resources (e.g., compute, time, etc.) and configurable escalation per stage and per incident.

In some examples, method 600 includes identifying a person within the entity to take over the task from AI agent 230, for example, based on organizational data. For example, agentic escalation system 110 can analyze organizational data to identify a person within the organization or entity that is suitable for taking over the task from AI agent 230. Specifically, agentic escalation system 110 can determine an organizational unit (e.g., a team, a business unit, etc.) within the entity that is associated with the incident and identify on-call human support with the subject matter knowledge within the organizational unit for a handoff. By identifying the right subject matter expert for an escalation, the present disclosure can improve the efficiency of the transition between an AI agent and a human agent.

At step 650, method 600 includes receiving an input from a device associated with the human agent. For example, agentic escalation system 110 can receive an input from a device associated with human operator 220 to complete the task that AI agent 230 was previously unsuccessful.

At step 660, method 600 includes proceeding with the incident resolution process, using the AI model, based on the input from the device associated with the human agent. For example, agentic escalation system 110 can proceed with the incident resolution process by assigning AI agent 230 to carry out the subsequent task. As follows, the present disclosure can provide various technical benefits such as providing faster and more accurate escalation paths, enabling proactive management, and thereby improving efficiency of the incident resolution process.

In some examples, method 600 includes generating an incident resolution report including an overview of the incident resolution process and corresponding evidence. For example, agentic escalation system 110 can generate, for a human agent (e.g., human operator 220), a report providing a comprehensive overview of attempted solutions or activities, reasons, and/or evidence, history, and on for each lifecycle stage. The context sharing can facilitate an efficient and seamless transition between an AI agent and a human agent by providing the human agent with necessary context and ensuring that the human agent does not repeat the unsuccessful solutions.

The disclosure now turns to a further discussion of example software models and devices that can be used to implement the technologies described herein.

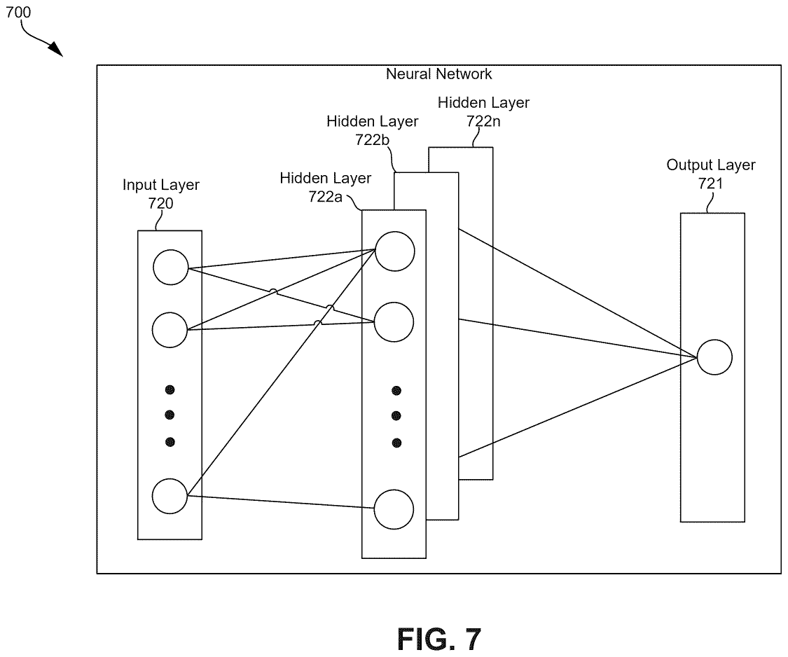

FIG. 7 is a diagram illustrating an example of a deep learning neural network 700 that can be used to implement all or a portion of the systems and techniques described herein, according to some examples of the present disclosure. For example, the neural network 700 can be used to implement the AI model 218 of the agentic escalation system 110 and/or any other software model(s) described herein (and/or component thereof).

An input layer 720 can be configured to receive data such as data included in agentic escalation system 110 and/or any other data described herein. Neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. Neural network 700 further includes an output layer 721 that provides an output resulting from the processing performed by the hidden layers 722a, 722b, through 722n.

Neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example neural network includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as a transformer, autoencoder, Deep Belief Net (DBN), Recurrent Neural Network (RNN), an encoder and/or decoder network, among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

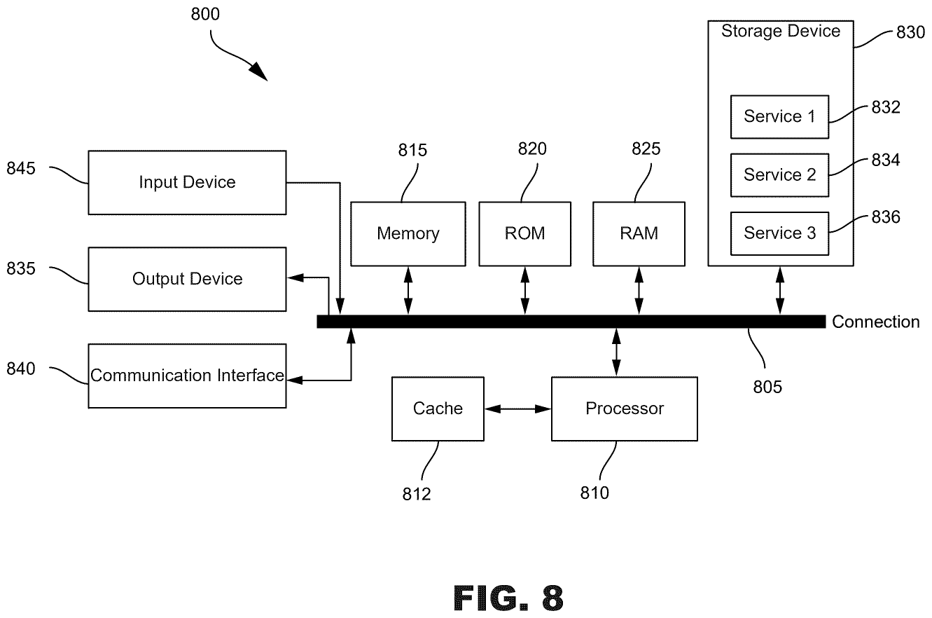

FIG. 8 illustrates an example processor-based system with which some examples of the subject technology can be implemented. For example, processor-based system 800 can be any computing device making up agentic escalation system 110, any of the client devices 116, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some implementations, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communication interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the present disclosure include:

Aspect 1. A computer-implemented method comprising: identifying an incident in a managed network; initiating an incident resolution process, using an artificial intelligence (AI) model, to determine a resolution for the incident; tracking one or more performance metrics associated with the incident resolution process; in response to determining that at least one of the one or more performance metrics exceeds a respective threshold, enabling a human agent to participate in the incident resolution process; receiving an input from a device associated with the human agent; and proceeding with the incident resolution process, using the AI model, based on the input from the device associated with the human agent.

Aspect 2. The computer-implemented method of Aspect 1, wherein the incident resolution process comprises: assessing an impact of the incident in the managed network; analyzing a cause of the incident; and determining the resolution for the incident.

Aspect 3. The computer-implemented method of any of Aspects 1 to 2, wherein the one or more performance metrics include a time-based metric.

Aspect 4. The computer-implemented method of any of Aspects 1 to 3, wherein the one or more performance metrics include an action-based metric.

Aspect 5. The computer-implemented method of any of Aspects 1 to 4, further comprising: identifying the human agent based on a mapping of the managed network.

Aspect 6. The computer-implemented method of any of Aspects 1 to 5, further comprising: generating a progress report, prior to enabling the human agent to participate in the incident resolution process, to transmit to the device associated with the human agent.

Aspect 7. The computer-implemented method of any of Aspects 1 to 6, further comprising: determining the respective threshold based on a service-level agreement.

Aspect 8. The computer-implemented method of any of Aspects 1 to 7, further comprising: determining the respective threshold based on historical data associated with the managed network.

Aspect 9. The computer-implemented method of any of Aspects 1 to 8, further comprising: adjusting the respective threshold based on a progress of the incident resolution process.

Aspect 10. The computer-implemented method of any of Aspects 1 to 9, further comprising: generating an incident resolution report including an overview of the incident resolution process and corresponding evidence.

Aspect 11. A system comprising: one or more processors; and at least one computer-readable storage medium having stored therein instructions which, when executed by the one or more processors, cause the one or more processors to: identify an incident in a managed network; initiate an incident resolution process, using an artificial intelligence (AI) model, to determine a resolution for the incident; track one or more performance metrics associated with the incident resolution process; in response to determining that at least one of the one or more performance metrics exceeds a respective threshold, enable a human agent to participate in the incident resolution process; receive an input from a device associated with the human agent; and proceed with the incident resolution process, using the AI model, based on the input from the device associated with the human agent.

Aspect 12. The system of Aspect 11, wherein the incident resolution process comprises: assessing an impact of the incident in the managed network; analyzing a cause of the incident; and determining the resolution for the incident.

Aspect 13. The system of any of Aspects 11 to 12, wherein the one or more performance metrics include a time-based metric.

Aspect 14. The system of any of Aspects 11 to 13, wherein the one or more performance metrics include an action-based metric.

Aspect 15. The system of any of Aspects 11 to 14, wherein the instructions, when executed by the one or more processors, cause the one or more processors to: identify the human agent based on a mapping of the managed network.

Aspect 16. The system of any of Aspects 11 to 15, wherein the instructions, when executed by the one or more processors, cause the one or more processors to: generate a progress report, prior to enabling the human agent to participate in the incident resolution process, to transmit to the device associated with the human agent.

Aspect 17. The system of any of Aspects 11 to 16, wherein the instructions, when executed by the one or more processors, cause the one or more processors to: determine the respective threshold based on a service-level agreement.

Aspect 18. The system of any of Aspects 11 to 17, wherein the instructions, when executed by the one or more processors, cause the one or more processors to: determine the respective threshold based on historical data associated with the managed network.

Aspect 19. The system of any of Aspects 11 to 18, wherein the instructions, when executed by the one or more processors, cause the one or more processors to: adjust the respective threshold based on a progress of the incident resolution process.

Aspect 20. A non-transitory computer-readable medium having instructions stored thereon that, when executed by at least one computing device, cause the at least one computing device to perform a method according to any of Aspects 1 to 10.

Aspect 21. A system comprising means for performing a method according to any of Aspects 1 to 10.

What is claimed is:

1. A computer-implemented method comprising:
identifying an incident in a managed network;
initiating an incident resolution process, using an artificial intelligence (AI) model, to determine a resolution for the incident;
tracking one or more performance metrics associated with the incident resolution process;
in response to determining that at least one of the one or more performance metrics exceeds a respective threshold, enabling a human agent to participate in the incident resolution process;
receiving an input from a device associated with the human agent; and
proceeding with the incident resolution process, using the AI model, based on the input from the device associated with the human agent.

2. The computer-implemented method of claim 1, wherein the incident resolution process comprises:
assessing an impact of the incident in the managed network;
analyzing a cause of the incident; and
determining the resolution for the incident.

3. The computer-implemented method of claim 1, wherein the one or more performance metrics include a time-based metric.

4. The computer-implemented method of claim 1, wherein the one or more performance metrics include an action-based metric.

5. The computer-implemented method of claim 1, further comprising:
identifying the human agent based on a mapping of the managed network.

6. The computer-implemented method of claim 1, further comprising:
generating a progress report, prior to enabling the human agent to participate in the incident resolution process, to transmit to the device associated with the human agent.

7. The computer-implemented method of claim 1, further comprising:
determining the respective threshold based on a service-level agreement.

8. The computer-implemented method of claim 1, further comprising:
determining the respective threshold based on historical data associated with the managed network.

9. The computer-implemented method of claim 1, further comprising:
adjusting the respective threshold based on a progress of the incident resolution process.

10. The computer-implemented method of claim 1, further comprising:
generating an incident resolution report including an overview of the incident resolution process and corresponding evidence.

11. A system comprising:
one or more processors; and
at least one computer-readable storage medium having stored therein instructions which, when executed by the one or more processors, cause the one or more processors to:
identify an incident in a managed network;
initiate an incident resolution process, using an artificial intelligence (AI) model, to determine a resolution for the incident;
track one or more performance metrics associated with the incident resolution process;
in response to determining that at least one of the one or more performance metrics exceeds a respective threshold, enable a human agent to participate in the incident resolution process;
receive an input from a device associated with the human agent; and
proceed with the incident resolution process, using the AI model, based on the input from the device associated with the human agent.

12. The system of claim 11, wherein the incident resolution process comprises:
assessing an impact of the incident in the managed network;
analyzing a cause of the incident; and
determining the resolution for the incident.

13. The system of claim 11, wherein the one or more performance metrics include a time-based metric.

14. The system of claim 11, wherein the one or more performance metrics include an action-based metric.

15. The system of claim 11, wherein the instructions, when executed by the one or more processors, cause the one or more processors to:
identify the human agent based on a mapping of the managed network.

16. The system of claim 11, wherein the instructions, when executed by the one or more processors, cause the one or more processors to:
generate a progress report, prior to enabling the human agent to participate in the incident resolution process, to transmit to the device associated with the human agent.

17. The system of claim 11, wherein the instructions, when executed by the one or more processors, cause the one or more processors to:
determine the respective threshold based on a service-level agreement.

18. The system of claim 11, wherein the instructions, when executed by the one or more processors, cause the one or more processors to:
determine the respective threshold based on historical data associated with the managed network.

19. The system of claim 11, wherein the instructions, when executed by the one or more processors, cause the one or more processors to:
adjust the respective threshold based on a progress of the incident resolution process.

20. A non-transitory computer-readable medium having stored thereon instructions which, when executed by one or more processors, cause the one or more processors to:
identify an incident in a managed network;
initiate an incident resolution process, using an artificial intelligence (AI) model, to determine a resolution for the incident;
track one or more performance metrics associated with the incident resolution process;
in response to determining that at least one of the one or more performance metrics exceeds a respective threshold, enable a human agent to participate in the incident resolution process;
receive an input from a device associated with the human agent; and
proceed with the incident resolution process, using the AI model, based on the input from the device associated with the human agent.
